(19) United States
(12) Patent Application Publication
(10) Pub. No.: US 2017/0065123 A1
(43) Pub. Date: Mar. 9, 2017

(54) MULTI-PART COOKING RING FOR USE WITH A SUBSTANTIALLY PLANAR FOOD ITEM

(71) Applicant: Alan J. Fox, Grand Ledge, MI (US)

(72) Inventor: Alan J. Fox, Grand Ledge, MI (US)

(21) Appl. No.: 15/252,316

(22) Filed: Aug. 31, 2016

Related U.S. Application Data
(60) Provisional application No. 62/215,329, filed on Sep. 8, 2015.

(51) Int. Cl. A47J 37/01; A21D 13/00

(52) U.S. Cl. CPC A47J 37/01; A21D 13/007

(57) ABSTRACT

A cooking utensil includes an outer ring. A bottom flange extends inward from the outer ring. The bottom flange is configured to support an outer edge of a substantially rigid food item from below. The bottom flange defines a lower oculus configured to allow unimpeded thermal transfer therethrough, and thermal transfer is at least partially impeded through the bottom flange. A top flange extends inward from the outer ring and is configured to extend over the outer edge of the substantially rigid food item. The top flange defines an upper oculus. The upper oculus is configured to allow unimpeded thermal transfer therethrough, and thermal transfer is at least partially impeded through the top flange.

### CROSS-REFERENCE TO RELATED APPLICATION

This application claims priority to and the benefit under 35 U.S.C. §119(e) of U.S. Provisional Patent Application No. 62/215,329 filed on Sep. 8, 2015, entitled “MULTI-PART COOKING RING FOR USE WITH A SUBSTANTIALLY PLANAR FOOD ITEM,” the entire disclosure of which is hereby incorporated herein by reference.

### BACKGROUND OF THE INVENTION

Pizza is a very popular American food. Fresh or frozen pizza is most often placed directly on an oven rack for cooking. Typically, when the pizza is being cooked, the pizza must be placed on or moved from the oven by sliding the pizza from a portable flat surface onto a hot rack. This can require the use of additional kitchen tools, such as spatulas or similar utensils to slide under and manipulate the frozen or cooked pizza. Use of such utensils can result in the user's hand directly contacting the cooked pizza or a portion of the oven that may result in discomfort to the user. Additionally, due to the toppings included within a pizza, the outer portion of the pizza that includes a bread-type crust typically cooks faster than the central portion of the pizza that includes various toppings. Accordingly, it is common that a frozen pizza when being cooked can appear to be fully cooked in the crust, but undercooked in the center where cooking can take longer. However, where the pizza is cooked for longer periods of time, the outer crust can be burned in order to achieve a fully cooked central portion of the pizza.

During manipulation of the pizza during cooking, conventional methods for manipulating the pizza from the oven to a cooling surface can utilize large tools including a long-handled wooded pizza deep. Such large utensils can require skill and practice. Additionally, conventional methods for cooking the pizza can result in the pizza being dropped, become misshapen, handled by unclean kitchen items, or other undesirable occurrences.

### SUMMARY

One aspect of the present disclosure is a cooking utensil including an outer ring. A bottom flange extends inward from the outer ring. The bottom flange is configured to support an outer edge of a substantially rigid food item from below. The bottom flange defines a lower oculus configured to allow unimpeded thermal transfer therethrough, and thermal transfer is at least partially impeded through the bottom flange. A top flange extends inward from the outer ring and is configured to extend over the outer edge of the substantially rigid food item. The top flange defines an upper oculus. The upper oculus is configured to allow unimpeded thermal transfer therethrough, and thermal transfer is at least partially impeded through the top flange.

In another aspect, a method for cooking a substantially planar food item includes providing a substantially planar food item and providing a multi-part cooking ring having a plurality of selectively separable submembers, each submember having a connecting mechanism disposed at each of first and second ends for engaging the connecting mechanism of at least one other submember of the plurality of submembers. The method also includes placing an outer edge of the substantially planar food item within a heat-impeding channel defined by top and bottom flanges of each of the submembers of the multi-part cooking ring. The method further includes engaging the connecting mechanisms of the plurality of submembers to substantially secure the outer edge of the substantially planar food item within a heat-impeding channel. The method also includes disposing the cooking ring and the substantially planar food item secured therein into a heating cavity of a cooking appliance wherein a bottom surface of the substantially planar food item extends across a lower oculus defined by the bottom flange to provide unimpeded heat transfer from the heating cavity, through the lower oculus and into the bottom of the substantially planar food item. The method further includes cooking the substantially planar food item in the heating cavity to achieve a predetermined doneness of the substantially planar food item to define a planar cooked food item, wherein during cooking the heat-impeding channel at least partially limits heat transfer from the heating cavity to the outer edge of the substantially planar food item. The method also includes removing the planar cooked food item and the cooking ring from the heating cavity when the predetermined doneness of the substantially planar food item is reached. The method further includes disposing the planar cooked food item and the cooking ring on a cooling surface, wherein the planar cooked food item remains substantially secured within the heat-impeding channel and separating the submembers and removing the submembers of the cooking ring from around the planar cooked food item, wherein removal of the submembers is accomplished without substantially lifting the planar cooked food item from the cooling surface.

In another aspect, a cooking utensil includes an outer ring defined by a plurality of submembers. A bottom flange extends inward from each submember of the outer ring. The bottom flange is configured to support an outer edge of a substantially rigid food item from below. The bottom flange defines a lower oculus configured to allow unimpeded thermal transfer therethrough. Thermal transfer is at least partially impeded through the bottom flange. Each submember includes at least one tab that selectively extends into an adjacent submember. The at least one tab selectively secures the plurality of arcuate submembers together to define a use state of the outer ring. The plurality of submembers is selectively detachable to define a collapsed state of the outer ring.

These and other features, advantages, and objects of the present device will be further understood and appreciated by those skilled in the art upon studying the following specification, claims, and appended drawings.

### BRIEF DESCRIPTION OF THE DRAWINGS

FIG. 1 is a cross-sectional view of a cooking appliance illustrating an aspect of the cooking ring disposed in a heating cavity of the cooking appliance during use;

FIG. 2 is an enlarged cross-sectional view of the cooking ring of FIG. 1 taken at area II;

FIG. 3 is a top plan view of a multi-part cooking ring shown in a detached position and partially encircling an outer edge of a substantially rigid food member, exemplified by a pizza;

FIG. 4 is a side elevation of the cooking ring of FIG. 3 illustrating a solid outer ring of the cooking ring;

FIG. 5 is a side elevation view of an alternate aspect of the cooking ring having a plurality of apertures defined within the outer ring of the cooking ring;

FIG. 6 is a side elevational view of an alternate aspect of the cooking ring illustrating a vertically operable band used to open and close a plurality of apertures within the outer ring;

FIG. 7 is a cross-sectional view of the cooking ring of FIG. 3 taken along line VII-VII and illustrating an arcuate shaped outer ring;

FIG. 8 is a cross-sectional view of an alternate aspect of the cooking ring;

FIG. 9 is a top plan view of an alternate aspect of the cooking ring illustrating handle members extending outward from the outer ring;

FIG. 10 is a cross-sectional view of an alternate aspect of the cooking ring;

FIG. 11 is a top plan view of an alternate aspect of the cooking ring;

FIG. 12 is a cross-sectional view of the cooking ring of FIG. 11 taken along line XII-XII;

FIG. 13 is a cross-sectional view of the cooking ring of FIG. 11 taken along line XIII-XIII;

FIG. 14 is a top plan view of an alternate aspect of the cooking ring illustrating a rectangular configuration of the cooking ring;

FIG. 15 is a schematic linear flow diagram illustrating a method for cooking a substantially planar food item using an aspect of the cooking ring;

FIG. 16 is a schematic elevational view of two opposing submembers of the outer ring in the collapsed state and exemplifying an aspect of the tab receptacle;

FIG. 17 is a schematic elevational view of the outer ring of FIG. 16 showing the two opposing submembers placed in the use state; and

FIG. 18 is a cross-sectional view of the tab receptacle of FIG. 16 taken along XVII-XVII.

### DETAILED DESCRIPTION

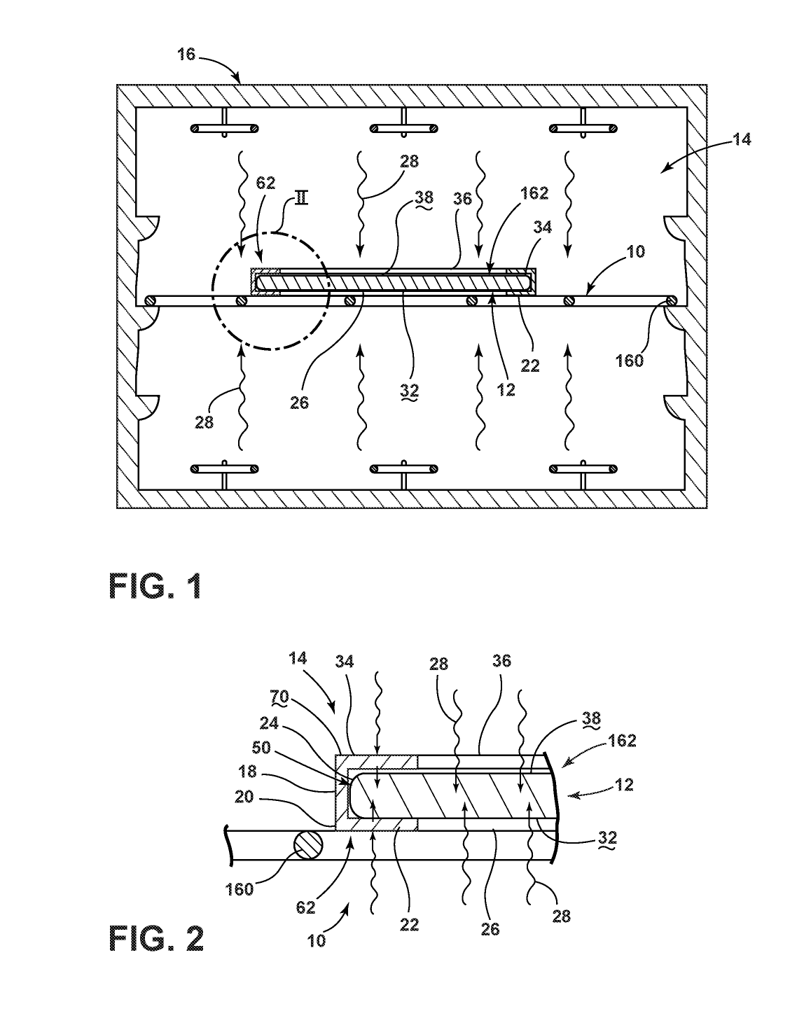

For purposes of description herein the terms “upper,” “lower,” “right,” “left,” “rear,” “front,” “vertical,” “horizontal,” and derivatives thereof shall relate to the assembly as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

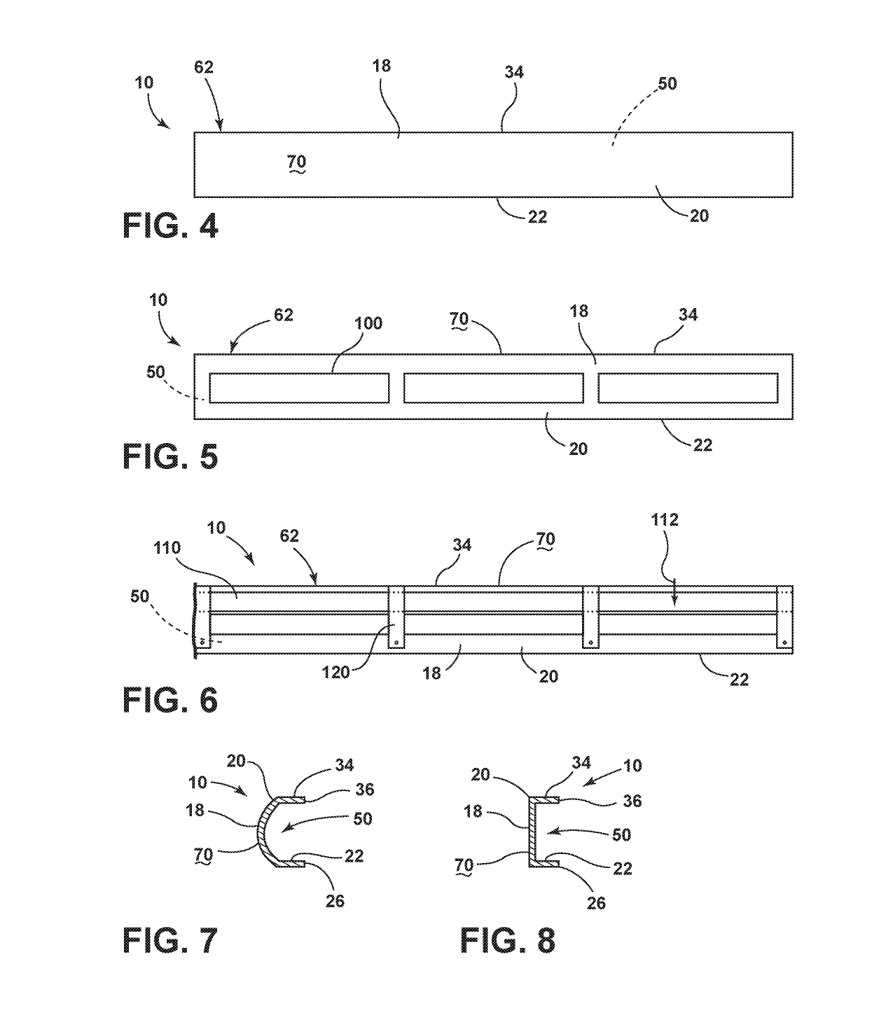

As shown in FIGS. 1-14, reference numeral 10 generally refers to a multi-part cooking ring for use in cooking a substantially rigid food item 12 within a heating cavity 14 of a cooking appliance 16. According to the various embodiments, a cooking utensil taking the form of a multi-part cooking ring 10 can include an outer ring 18 that extends around the perimeter 20 of the cooking utensil. A bottom flange 22 extends inward from the outer ring 18, where the bottom flange 22 is configured to support an outer edge 24 of a substantially rigid food item 12 from below. The bottom flange 22 defines a lower oculus 26 that is configured to allow unimpeded thermal transfer of heat 28 from a heating source 30 of the cooking appliance 16 therethrough. Simultaneously, thermal transfer of heat 28 from a heating source 30 of the cooking appliance 16 is at least partially impeded to the outer edge 24 of the bottom surface 32 of the substantially rigid food item 12 by the bottom flange 22. A top flange 34 extends inward from the outer ring 18 and is configured to extend over the outer edge 24 of the substantially rigid food item 12. The top flange 34 defines an upper oculus 36, wherein the upper oculus 36 is configured to allow unimpeded thermal transfer of heat 28 therethrough. At the same time, thermal transfer of heat 28 is at least partially impeded through the top flange 34, such that heat 28 is at least partially impeded from reaching into the top surface 38 of the outer edge 24 of the substantially rigid food item 12.

Referring again to FIGS. 1-14, it is contemplated that the substantially rigid food item 12 can take the form of a frozen pizza, where the frozen state of the pizza causes the food item 12 to be substantially rigid and at least partially resistant to bending, sagging or otherwise sliding out from the multi-part cooking ring 10 during use.

Referring again to FIGS. 1-14, it is contemplated that the multi-part cooking ring 10 can include a heat-impeding channel 50 that is defined by the outer ring 18 in the top and bottom flanges 22. In this manner, the outer edge 24 of the substantially rigid food item 12 can be placed within the heat-impeding channel 50 such that the top and bottom flanges 34, 22 and the outer ring 18 extend around the bottom surface 32 and top surface 38 of the outer edge 24 of the substantially rigid food item 12. In this manner, the substantially rigid food item 12 is at least partially secured within the cooking ring 10 such that substantially rigid food items 12 can be manipulated and moved from one location to another by grasping, holding, or otherwise engaging only the cooking ring 10.

According to the various embodiments, the multi-part cooking ring 10 is configured to allow the user to place the cooking ring 10 around the substantially rigid food item 12, such as a frozen pizza, without touching or otherwise engaging the frozen pizza. In this manner, the outer ring 18, top flange 34 and bottom flange 22 are defined by a plurality of submembers 60 that are selectively attachable to define the use state 62 of the cooking ring 10. The plurality of submembers 60 are selectively detachable to define a collapsed state 64 of the cooking ring 10. In use, the substantially rigid food item 12 can be placed upon a surface and the multi-part cooking ring 10, in the collapsed state 64, can be placed around the outer edge 24 of the substantially rigid food item 12. Movement of the multi-part cooking ring 10 toward the use state 62 serves to engage each of the plurality of submembers 60 and slides the bottom flange 22 under the outer edge 24 of the substantially rigid food item 12. Each of the plurality of submembers 60 can include at least one tab 66 that extends into an adjacent submember 60. The at least one tab 66 is configured to selectively secure the plurality of arcuate submembers 60 together to define the use state 62 of the cooking ring 10.

According to the various embodiments, as exemplified in FIGS. 1-14, each of the plurality of submembers 60 can also include a tab receptacle 68 for selectively receiving at least one of the tabs 66 to further secure each of the plurality of submembers 60 into the use state 62 to define the use state 62 of the cooking ring 10. Accordingly, as the plurality of submembers 60 are engaged into the use state 62 of the cooking ring 10, the bottom flange 22 is slid under the outer edge 24 of the substantially rigid food item 12 and the outer edge 24 of the substantially rigid food item 12 is secured within the heat-impeding channel 50 of the multi-part cooking ring 10. Once secured therein, the user can grasp, hold, or otherwise engage the outer surface 70 of the cooking ring 10 to manipulate both the multi-part cooking ring 10 and the substantially rigid food item 12 for movement from one location to another. In this manner, the user can manipulate only the cooking ring 10 to place the cooking ring 10 and the substantially rigid food item 12 within a heating cavity 14 of the appliance without the aid of, or substantially without the aid of, an oven mitt or other hand covering device.

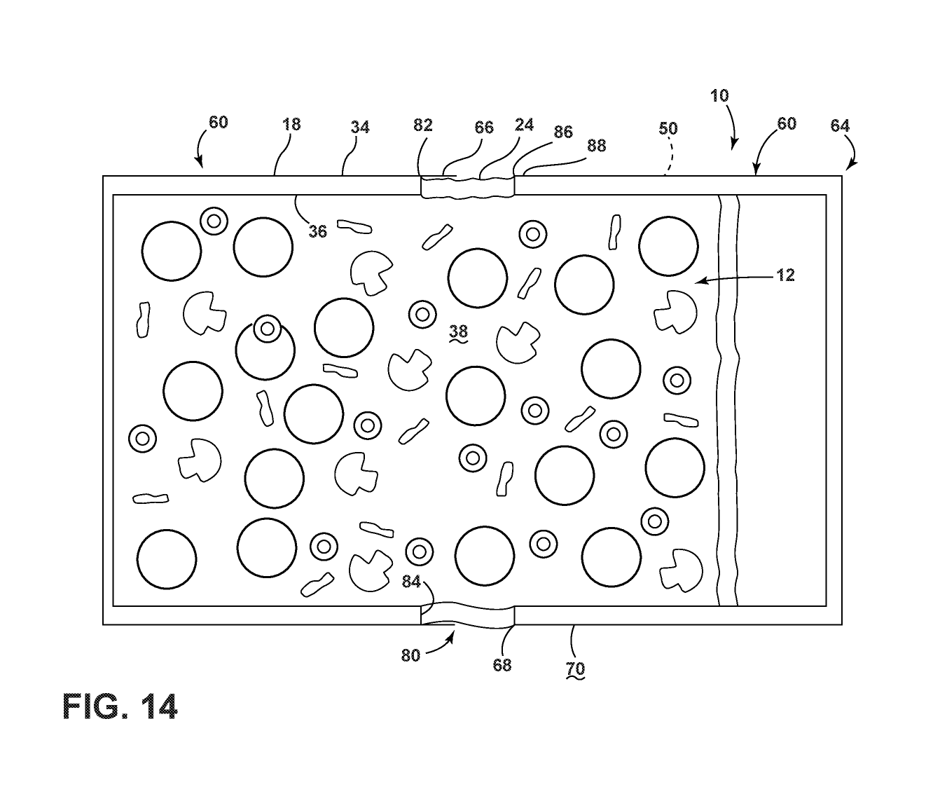

Referring to FIGS. 1-14, while the submembers 60 typically form a circular or rectangular outer ring 18, it is contemplated that each of the plurality of submembers 60 can include arcuate submembers, linear submembers, angular submembers, combinations thereof, and other shapes such that the cooking ring 10 can take the form of a circle, oval, ellipse, rectangle (exemplified in FIG. 14), square, irregular shape, other polygon, various arcuate shapes, combinations thereof and other substantially similar shapes that correspond to any one of various substantially rigid food items 12. It is also contemplated that the outer ring 18 can include a plurality of slidable links that can be bent and shaped into various irregular forms to securely engage a substantially rigid food item 12 having an irregular outer profile. Additionally, it is contemplated that the cooking ring 10 can be made up of two or more submembers 60 that can be connected together to form the use state 62 of the cooking ring 10.

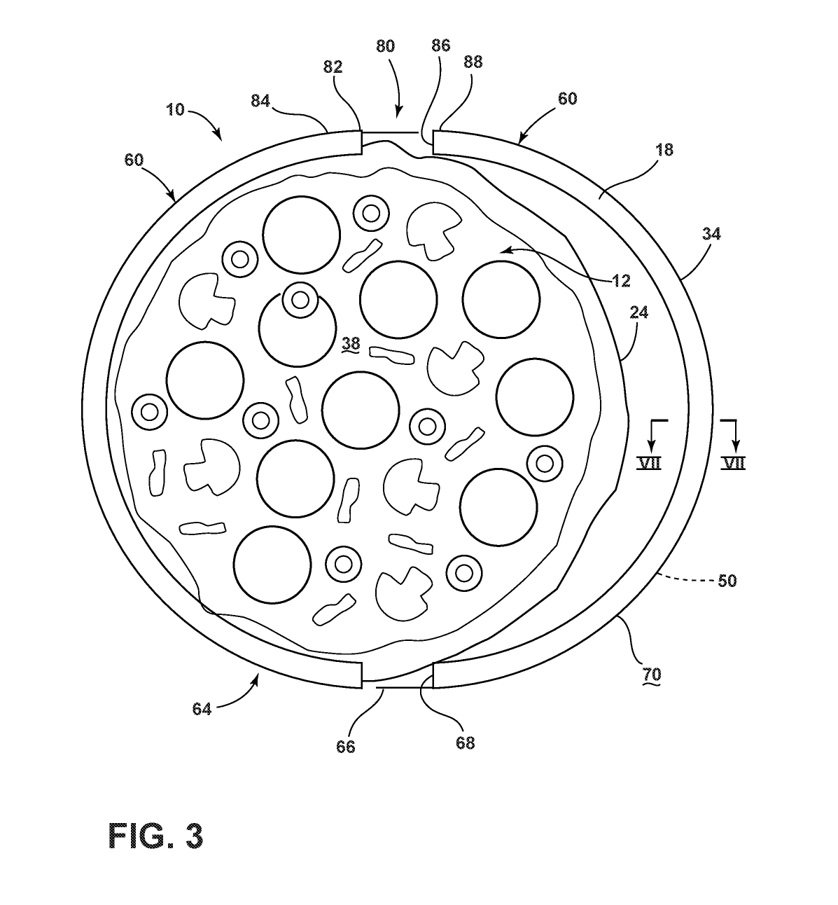

Referring again to FIGS. 1-14, each of the plurality of submembers 60 of the cooking ring 10 can include part of an attachment mechanism 80 for the multi-part cooking ring 10 (exemplified in FIG. 3 as the tabs 66). In this manner, each of the submembers 60 can include a first portion 82 of the attachment mechanism 80 at a first end 84 of the submember 60 and a second portion 86 of the attachment mechanism 80 at a second end 88 of the submember 60. Accordingly, it is contemplated that each of the first portions 82 of the attachment mechanism 80 are disposed at the first ends 84 of each submember 60 and are selectively engageable with the second portions 86 of the attachment mechanism 80 disposed at the second ends 88 of any one of the other plurality of submembers 60. Accordingly, the attachment mechanisms 80 are configured to substantially engage each of the submembers 60 together to form the use state 62 of the cooking ring 10. It is contemplated that the attachment mechanism 80 can be defined by various mating features that can include, but are not limited to, opposing tabs, tab/receptacle combinations, protrusion/receptacle configurations, tab/slot configurations, and other similar mating configurations that can be engaged through a sliding engagement of the first and second portions 82, 86 of the attachment mechanism 80. It is also contemplated that the attachment mechanism 80 can be defined by various fastening mechanisms that can include, but are not limited to, hasps, clasps, operable tabs, links, hooks threaded fasteners, hinged fasteners, combinations thereof, and other similar fastening mechanisms.

Referring now to FIGS. 5, it is contemplated that the outer ring 18 can include at least one aperture or a plurality of apertures 100 defined therein. In such an embodiment, the plurality of apertures 100 are configured to allow at least some unimpeded thermal transfer, or selective thermal transfer, of heat 28 between an outer surface 70 of the outer ring 18 and into the heat-impeding channel 50 defined by the outer ring 18 in the top and bottom flanges 34, 22. According to the various embodiments, it is contemplated that each of submembers 60 can include one or more apertures 100 such that when the submembers 60 are connected to form the use state 62 of the cooking ring 10, the outer ring 18 of the cooking ring 10 includes a plurality of apertures 100 that provide for limited and/or selective thermal transfer of heat 28 into the heat-impeding channel 50.

Referring now to FIG. 6, it is contemplated that the outer ring 18 can include a vertically operable band 110 that is selectively operable between a plurality of vertical positions 112, such as between open and closed positions. The various vertical positions 112 can include a closed state, wherein the vertically operable band 110 covers the plurality of apertures 100. The plurality of vertical positions 112 can also include an open state, wherein the vertically operable band 110 is moved away from the closed state, to at least partially define the plurality of apertures 100. It is also contemplated that the vertical positions 112 of the vertically operable band 110 can include a fully open state wherein the operable band 110 is completely moved away from the various apertures 100 defined within the outer ring 18.

Referring again to FIG. 6, it is contemplated that each of the plurality of submembers 60 of the multi-part cooking ring 10 can include a separate vertically operable band 110 that is independently operable between the plurality of vertical positions 112, such as between open and closed positions. In this manner, portions of the apertures 100 can be opened or closed to varying degrees, depending on user preference, various idiosyncrasies of the user's oven, and other factors. The vertically operable bands 110 of each of the submembers 60 can also be opened or closed depending upon the characteristics of the substantially rigid food item 12 being cooked within the multi-part cooking ring 10. By way of example, and not limitation, where a portion of the substantially rigid food item 12 has a thicker portion of the outer edge 24, the vertically operable bands 110 may be opened slightly more to allow for an increased amount of heat 28 to reach the larger portion of the outer edge 24 of the substantially rigid food item 12. Conversely, where the substantially rigid food item 12 has a thinner portion of the outer edge 24, the vertically operable band 110 may be moved toward the closed state to allow for less thermal transfer into the heat-impeding channel 50.

Referring again to FIG. 6, it is contemplated that each of the submembers 60 can include vertical tabs 120 that extend along portions of the outer edge 24 of each of the submembers 60. The vertical tabs 120 can serve as a guide for the vertically operable band 110 to manipulate the vertically operable band 110 between the plurality of vertical positions 112.

According to the various embodiments, the various vertically operable bands 110 of the multi-part cooking ring 10 can also be used to account for preferences of individuals who will be eating the substantially rigid food item 12. Accordingly, where an individual prefers a more crispy outer edge 24, the vertically operable bands 110 can be moved to expose more of the apertures 100 to allow greater transfer of heat 28 into the heat-impeding channel 50. An individual who prefers a softer outer edge 24 may prefer that the vertically operable bands 110 be moved more towards the closed state such that less thermal transfer occurs into the heat-impeding channel 50 of the multi-part cooking ring 10.

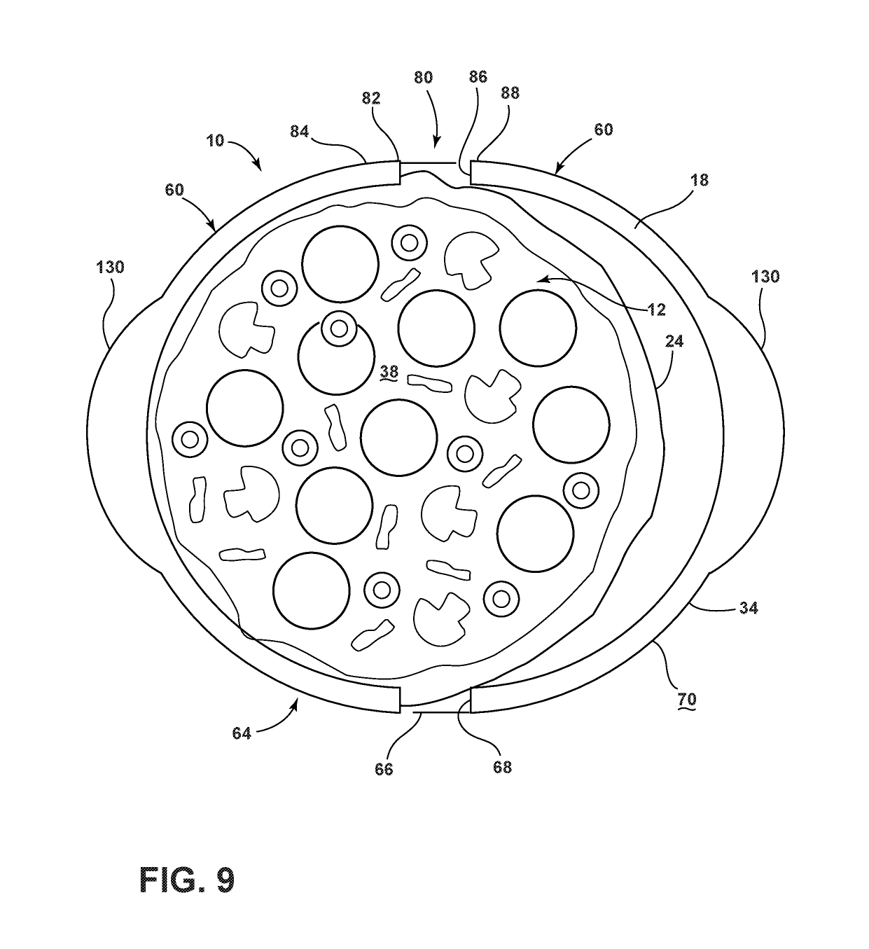

Referring now to FIG. 9, it is contemplated that each of the submembers 60 of the multi-part cooking ring 10 can include a handle member 130 that can be used for grasping the multi-part cooking ring 10 for manipulating the multi-part cooking ring 10 from one location to another. It is contemplated that these handle members 130 can be made of substantially heat-resistant materials, such as silicone, rubber, combinations thereof, or other similar material that may remain substantially cool to the touch when in a heated cooking appliance 16. In this manner, the handle members 130 can be easily grasped, using oven mitts, or in some cases, a bare hand, to remove the multi-part cooking ring 10 from a heating cavity 14 of a cooking appliance 16. Accordingly, the multi-part cooking ring 10 can be moved from one location to another without the aid of an additional utensil. A user may prefer to use an oven mitt or other similar hand-covering item, though such a hand-covering item may not be necessary.

Referring again to FIG. 9, it is contemplated that the handle members 130 disposed on each of the submembers 60 on each of the multi-part cooking ring 10 can be used to manipulate each of the submembers 60 relative to one another to operate the submembers 60 between the use state 62 and the collapsed state 64, to secure the substantially rigid food item 12 within the heat-impeding channel 50 or removing the substantially rigid food item 12 from the multi-part cooking ring 10.

Referring again to FIGS. 1-14, it is contemplated that the multi-part cooking ring 10, when in the collapsed state 64, can be placed into a substantially smaller space, such as a dishwasher for convenient cleaning or storage area after use. Accordingly, it is contemplated that the submembers 60 of the multi-part cooking ring 10 are made of a substantially dishwasher-safe material that can include, but is not limited to, metal, metal alloys, non-stick coated metals, silicone-coated materials, silicone, plastic, rubber, polymers, ceramic, combinations thereof and other similar at least partially thermal resistant materials that can at least partially limit the thermal transfer from the heating cavity 14 into the heat-impeding channel 50 of the multi-part cooking ring 10.

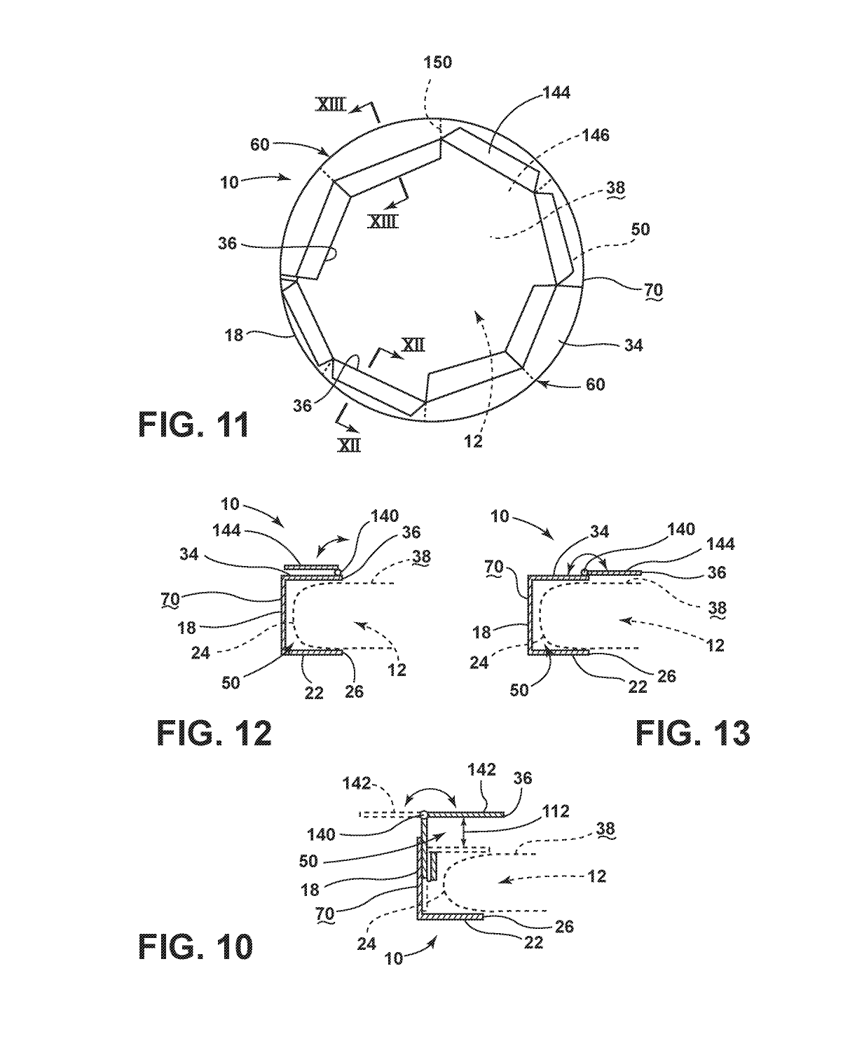

Referring now to FIG. 10, according to various aspects of the device, it is contemplated that the top flange 34 of the multi-part cooking ring 10 can be operable in a vertical direction along the outer ring 18 of the multi-part cooking ring 10. In this manner, where the substantially rigid and/or planar food item 12 has a thin profile, the top flange 34 of the multi-part cooking ring 10 can be moved downward to be closer to the outer edge 24 of the food item 12. Conversely, where the food item 12 has a thicker profile, the top flange 34 of the multi-part cooking ring 10 can be moved upward to provide enough space for the food item 12 to be placed in the heat-impeding channel 50.

Referring now to FIGS. 10-13, it is contemplated that the top flange 34 can include a hinged mechanism 140 for rotating portions of the top flange 34 away from the food item 12, such that portions of the outer edge 24 of the food item 12 can be exposed during cooking. Such a configuration may be desired where individuals prefer a crispy outer edge 24 of the food item 12. It is contemplated that each of the submembers 60 of the multi-part cooking ring 10 can include a rotationally operable top flange 142 that can be rotated over the food item 12 or away from the food item 12, as desired, depending on the particular user's preferences as to the cooked condition of the food item 12 (exemplified in FIG. 10). It is also contemplated that the top flange 34 can include an extension mechanism 144 that can extend the top flange 34 further over central portions 146 of the food item 12 where certain portions of the food item 12 are desired to be in a less-cooked state (exemplified in FIGS. 11-13). Such extension mechanisms 144 can be hingedly operable to rotate various layers of the extension mechanism 144 out over the food item 12. Extension mechanisms 144 can also be slidably extended out over portions of the food item 12 to extend the top flange 34 over portions of the food item 12. It is contemplated that each submember 60 of the multi-part cooking ring 10 can include its own extension mechanism 144 for each top flange 34. Accordingly, the user can adjust the level of doneness for various portions of the food item 12 during cooking in order to make some portions of the food item 12 more done or less done than others. It is contemplated that the extension mechanism 144 could be fully extended to cover or substantially cover the food item 12, thereby eliminating or substantially eliminating the upper oculus 36.

According to the various embodiments, it is contemplated that use of the multi-part cooking ring 10 can serve to substantially maintain the food item 12 in a substantially planar state during cooking. It is also contemplated that the heat-impeding channel 50 of the multi-part cooking ring 10 can be sized to allow for expansion of the outer edge 24 of the food item 12 during cooking, such as with a rising pizza crust, or other bread or pastry item that may rise or expand during cooking. It is also contemplated that the encircling nature of the multi-part cooking ring 10 can substantially protect portions of the outer edge 24 of the food item 12 to substantially prevent or limit crumbling, crackling, bumping, or other unintentional engagement or deformation of the food item 12 during cooking or manipulation of the food item 12 from one location to another. According to the various embodiments, the top flange 34 can include slots 150 configured to serve as a cutting guide for cutting the food item 12 into desired sections, typically substantially equal sections.

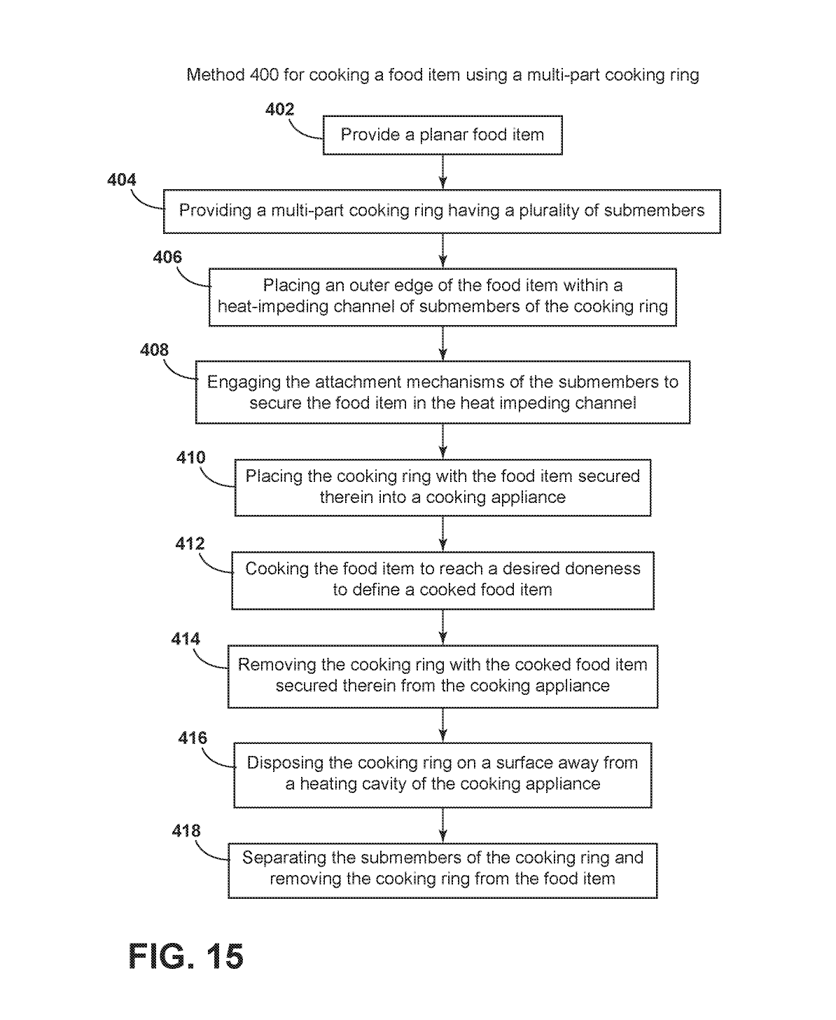

Referring now to FIGS. 1-15, having described the various aspects of the device, a method 400 is disclosed for cooking a substantially planar food item 12 utilizing various aspects of the multi-part cooking ring 10 described herein. According to the method 400, a substantially planar food item 12 is provided (step 402). Such substantially planar food items 12 can include, but are not limited to, frozen pizzas, uncooked pizzas, partially cooked pizzas, pies, quiches, pastries, pie crusts and other substantially planar items that can be cooked within a heating cavity 14 of a cooking appliance 16. According to the method 400, the multi-part cooking ring 10 can be provided, where the multi-part cooking ring 10 includes a plurality of selectively separable submembers 60 (step 404). It is contemplated that each submember 60 includes an attachment mechanism 80 disposed at each of the first and second ends 84, 88 of each submember 60 for engaging the attachment mechanism 80 of at least one other submember 60 of a plurality of submembers 60. An outer edge 24 of the substantially planar food item 12 is placed within a heat-impeding channel 50 defined by top and bottom flanges 34, 22 in an outer ring 18 of each of the submembers 60 of the multi-part cooking ring 10 (step 406). In this manner, each of the submembers 60 are placed around the outer edge 24 of the substantially planar food item 12 and are then engaged via the attachment mechanisms 80 of the plurality of submembers 60 to substantially secure the outer edge 24 of the substantially planar food item 12 within the heat-impeding channel 50 (step 408). The use of the attachment mechanism 80 of the plurality of submembers 60 is configured to place the cooking ring 10 in the use state 62. Conversely, separating the attachment mechanisms 80 of each of the submembers 60 places the cooking ring 10 in a collapsed state 64, for storage, cleaning, or other later use.

Referring again to FIGS. 1-15, according to the method 400, once the substantially planar food item 12 is secured within the heat-impeding channel 50 of the cooking ring 10, the cooking ring 10 and the substantially planar food item 12 are placed into a heating cavity 14 on a rack 160 of a cooking appliance 16. In this manner, a bottom surface 32 of the substantially planar food items 12 extends across or spans a lower oculus 26 defined by the bottom flange 22. Accordingly, the lower oculus 26 provides substantially unimpeded transfer of heat 28 from the heating cavity 14, through the lower oculus 26 and into the bottom of the substantially planar food item 12 (step 410). Once placed in the heating cavity 14, the substantially planar food item 12 is cooked within the heating cavity 14 to achieve a predetermined doneness of the substantially planar food item 12 to define a planar cooked food item 162 (step 412). During cooking, the heat-impeding channel 50 at least partially limits heat 28 transfer from the heating cavity 14 to portions of the outer edge 24 of the substantially planar food item 12 disposed within the heat-impeding channel 50 of the multi-part cooking ring 10. Once the predetermined doneness of the substantially planar food item 12 is reached, the planar cooked food item 162 and the cooking ring 10 are removed from the heating cavity 14. In this manner, the user can engage only the multi-part cooking ring 10 in order to move the planar cooked food item 162 from the heating cavity 14 to another location. According to the various embodiments, it is contemplated that the cooking ring 10 can be used to cook a substantially planar food item 12 in any one of various cooking appliances 16. Such cooking appliances 16 can include, but are not limited to, ovens, toaster ovens, grills, convection ovens, radiant heating ovens, and other similar cooking appliances 16.

According to the various embodiments, it is contemplated that the incorporation of the heat-impeding channel 50 into the multi-part cooking ring 10 can not only serve to limit the amount of heat 28 transferred to the outer edge 24 of the substantially planar food item 12, but can also prevent drippings and other portions of the food item 12 from falling away from the substantially planar food item 12 during cooking and falling onto a portion of the inner surface of the heating cavity 14 of the cooking appliance 16. In this manner, the use of the multi-part cooking ring 10 can contain drippings and substantially limit the amount of subsequent cleaning that may be necessary within the cooking appliance 16 after use of the multi-part cooking ring 10 to cook the substantially planar food item 12.

Once the cooking operation is complete, the planar cooked food item 162 and the cooking ring 10 can be removed from the heating cavity 14 when the predetermined doneness of the substantially planar food item 12 is reached (step 414). It is contemplated that before the predetermined doneness of the substantially planar food item 12 is reached, the user can manipulate the positioning of the cooking ring 10 and in turn, the substantially planar food item 12, during cooking. The substantially heat-resistant material of the multi-part cooking ring 10 can, in various embodiments, allow the user to grasp portions of the multi-part cooking ring 10 without the use of oven mitts, towels, or other hand-covering items, while the use of such hand-covering items may be advisable to prevent the user touching a portion of the interior cavity of the cooking appliance 16.

Once the planar cooked food item 162 disposed within the cooking ring 10 are removed from the heating cavity 14, the planar cooked food item 162 and the cooking ring 10 can be disposed on a cooling surface (step 416). During the movement of the planar cooked food item 162, the planar cooked food item 162 remains substantially secured within the heat-impeding channel 50 of the multi-part cooking ring 10. The cooling surface described herein can be any one of a number of surfaces that can include, but are not limited to, the cutting board, countertop, cooling rack, serving plate, or other substantially planar surface that can be used for cooling and/or serving the planar cooked food item 162. Such a planar surface can also include a warming table for keeping the planar cooked food item 162 at a warm temperature for serving at a later time.

Referring again to FIGS. 1-15, according to the method 400, once the planar cooked food item 162 and the cooking ring 10 are moved to a surface outside of the heating cavity 14, the submembers 60 of the multi-part cooking ring 10 can be separated and the submembers 60 of the cooking ring 10 removed from around the planar cooked food item 162 (step 418). In this manner, removal of the submembers 60 from around the planar cooked food item 162 can be accomplished without substantially lifting the planar cooked food item 162 from the surface. Accordingly, use of the multi-part cooking ring 10 can, according to the various embodiments, serve as the only utensil necessary for moving the substantially planar food item 12 and/or the planar cooked food item 162 from one location to a heating cavity 14 and from the heating cavity 14 to another location.

According to the various embodiments, it is contemplated that the multi-part cooking ring 10 can include two opposing submembers 60. It is also contemplated that the multi-part cooking ring 10 can include three or more submembers 60 that can be engaged to form a use state 62 of the multi-part cooking ring 10. The number of submembers 60 of the multi-part cooking ring 10 can be based upon several factors that can include, but are not limited to, the size of the cooking ring 10 in the use state 62, the material of the multi-part cooking ring 10, the height of the multi-part cooking ring 10 between the top and bottom flanges 34, 22, and other similar factors. It is further contemplated that the width, length, diameter and other dimensions of the cooking ring 10 can vary depending on the desired use. By way of example, and not limitation, one cooking ring 10 for small individual sized pizzas can be sized smaller than a separate cooking ring 10 for larger pizzas.

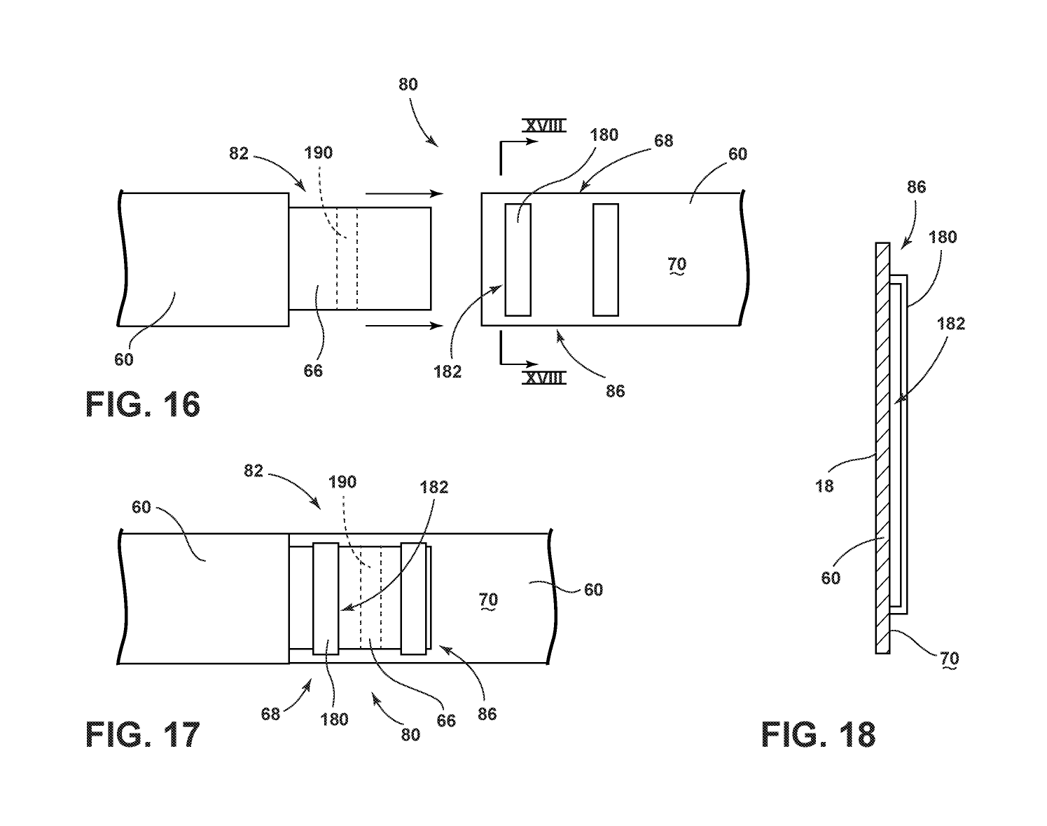

Referring now to FIGS. 16-18, an aspect of the attachment mechanism 80 is exemplified.

A first portion 82 of the attachment mechanism 80 includes the tab 66 that is selectively engageable with the second portion 86 of the attachment mechanism 80. According to this aspect of the device, the second portion 86 of the attachment mechanism 80 which is positioned at the second end 88 of the submember 60 includes at least one offset portion 180 of the outer ring 18 that defines an integral loop 182. In such an embodiment, it is contemplated that the offset portion 180 of the outer ring 18 can be stamped into the shape of the integral loop 182 that extends outward from the outer surface 70 of the outer ring 18 to define the integral loop 182 through which the tab 66 can extend. It is contemplated that the second portion 86 of the attachment mechanism 80 can be defined by a plurality of offset portions 180 that each define a separate integral loop 182 through which the tab 66 is disposed to define the use state 62 of the outer ring 18. Typically, the second portion 86 of the attachment mechanism 80 will include two offset portions 180 that each define an integral loop 182. It is contemplated that the various integral loops 182 can define the tab receptacles 68 for receiving the tab 66 of the opposing submember 60 for defining the use state 62 of the outer ring. It is also contemplated that the offset portion 180 can be defined by a separate member that is attached to a portion of the outer ring 18 to define the tab receptacle 68 through which the tab 66 is disposed to define the use state 62 of the outer ring 18.

According to the various embodiments, it is contemplated that the tab 66 and the tab receptacle 68 can define a detent engagement mechanism, where the tab 66 can include an interference-type engagement mechanism, such as a detent, protrusion, bent portion, or other similar geometry that can at least partially cause an outward deflection of the offset portion 180 as the interference member 190 of the tab 66 passes through the offset portion 180. The offset portion 180 would then return to its original shape after the interference member 190 of the tab 66 passes through the offset portion 180. The engagement of the tab 66 and the offset portions 180 through the use of the interference member 190 would further define an engagement between the tab 66 and the tab receptacle 68.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. A cooking utensil comprising:
an outer ring;
a bottom flange extending inward from the outer ring, the bottom flange configured to support an outer edge of a substantially rigid food item from below, the bottom flange defining a lower oculus configured to allow unimpeded thermal transfer therethrough, and wherein thermal transfer is at least partially impeded through the bottom flange; and
a top flange extending inward from the outer ring and configured to extend over the outer edge of the substantially rigid food item, the top flange defining an upper oculus, wherein the upper oculus is configured to allow unimpeded thermal transfer therethrough, and wherein thermal transfer is at least partially impeded through the top flange.

2. The cooking utensil of claim 1, wherein the substantially rigid food item is a frozen pizza.

3. The cooking utensil of claim 1, wherein the outer ring, top flange and bottom flange are defined by a plurality of arcuate submembers that are selectively attachable to define a cooking ring use state, and selectively detachable to define a collapsed state of the cooking ring.

4. The cooking utensil of claim 3, wherein each of the plurality of arcuate submembers includes at least one tab that extends into an adjacent arcuate submember, wherein the at least one tab selectively secures the plurality of arcuate submembers together to define the use state of the cooking ring.

5. The cooking utensil of claim 4, wherein at least one of the plurality of arcuate submembers includes a tab receptacle for selectively receiving the at least one tab to define the use state of the cooking ring.

6. The cooking utensil of claim 1, wherein the top flange includes slots configured to serve as a cutting guide for cutting the substantially rigid food item into substantially equal sections.

7. The cooking utensil of claim 1, wherein the outer ring includes a plurality of apertures defined therein, wherein each of the plurality of apertures provides for at least selective thermal transfer from an outer surface of the outer ring into a heat-impeding channel defined by the outer ring and the top and bottom flanges.

8. The cooking utensil of claim 7, wherein the outer ring includes a vertically operable band that is selectively operable between a plurality of vertical positions, wherein the plurality of vertical positions includes a closed state, wherein the vertically operable band covers the plurality of apertures, and an open state, wherein the vertically operable band is moved away from the closed state to at least partially define the plurality of apertures.

9. The cooking utensil of claim 1, wherein the outer ring is circular in shape.

10. A cooking utensil comprising:
an outer ring defined by a plurality of submembers; and
a bottom flange extending inward from each submember of the outer ring, the bottom flange configured to support an outer edge of a substantially rigid food item from below, the bottom flange defining a lower oculus configured to allow unimpeded thermal transfer therethrough, and wherein thermal transfer is at least partially impeded through the bottom flange, wherein each submember includes at least one tab that selectively extends into an adjacent submember, wherein the at least one tab selectively secures the plurality of arcuate submembers together to define a use state of the outer ring, the plurality of submembers being selectively detachable to define a collapsed state of the outer ring.

11. The cooking utensil of claim 10, wherein the plurality of submembers includes two opposing submembers.

12. The cooking utensil of claim 10, further comprising:
a top flange extending inward from each submember of the outer ring, wherein the top flange is rotationally operable to extend over the outer edge of the substantially rigid food item, the top flange defining an upper oculus.

13. The cooking utensil of claim 12, wherein the upper oculus is configured to allow unimpeded thermal transfer therethrough, and wherein thermal transfer is at least partially impeded through the top flange.

14. The cooking utensil of claim 10, wherein at least one of the plurality of submembers includes a tab receptacle for selectively receiving the at least one tab to define the use state of the outer cooking ring.

15. The cooking utensil of claim 14, wherein the tab receptacle is defined by at least one offset portion of the outer ring that defines an integral loop, wherein one of the at least one tabs of a submember is adapted to be selectively received within the integral loop of the adjacent submember.

16. The cooking utensil of claim 15, wherein the tab receptacle includes two offset portions.

17. A method for cooking a substantially planar food item, the method comprising steps of:
providing the substantially planar food item;
providing a multi-part cooking ring having a plurality of selectively separable submembers, each submember having a connecting mechanism disposed at each of first and second ends for engaging the connecting mechanism of at least one other submember of the plurality of submembers;
placing an outer edge of the substantially planar food item within a heat-impeding channel defined by top and bottom flanges of each of the submembers of the multi-part cooking ring;
engaging the connecting mechanisms of the plurality of submembers to substantially secure the outer edge of the substantially planar food item within a heat-impeding channel;
disposing the cooking ring and the substantially planar food item secured therein into a heating cavity of a cooking appliance wherein a bottom surface of the substantially planar food item extends across a lower oculus defined by the bottom flange to provide unimpeded heat transfer from the heating cavity, through the lower oculus and into the bottom of the substantially planar food item;
cooking the substantially planar food item in the heating cavity to achieve a predetermined doneness of the substantially planar food item to define a planar cooked food item, wherein during cooking the heat-impeding channel at least partially limits heat transfer from the heating cavity to the outer edge of the substantially planar food item;
removing the planar cooked food item and the cooking ring from the heating cavity when the predetermined doneness of the substantially planar food item is reached;
disposing the planar cooked food item and the cooking ring on a cooling surface, wherein the planar cooked food item remains substantially secured within the heat-impeding channel; and
separating the submembers and removing the submembers of the cooking ring from around the planar cooked food item, wherein removal of the submembers is accomplished without substantially lifting the planar cooked food item from the cooling surface.

18. The method of claim 17, wherein the cooking ring includes two opposing submembers.

19. The method of claim 17, wherein the cooking ring is circular and the submembers are arcuate submembers.

20. The method of claim 17, wherein the step of engaging the connecting mechanisms includes positioning a vertically operable band of each of the submembers to operate at least one aperture of each of the submembers between open and closed positions, wherein operation of each of the vertically operable bands is configured to adjust the thermal transfer of heat from the heating cavity into the heat-impeding channel.
